(19) United States
(12) Patent Application Publication
(10) Pub. No.: US 2026/0195548 A1
(43) Pub. Date: Jul. 9, 2026

(54) LARGE LANGUAGE MODEL TRANSLATOR

(71) Applicant: Disney Enterprises, Inc., Burbank, CA (US)

(72) Inventors: Clifford Hilo, Santa Monica, CA (US); Guglielmo Camporese, Zurich (CH); Ana Jessica Payes, Granada Hills, CA (US); Shinobu Hattori, Los Angeles, CA (US); Mitsuaki Watanabe, Queens, NY (US); Dan Sebastian Ruta, Zurich (CH)

(73) Assignee: Disney Enterprises, Inc., Burbank, CA (US)

(21) Appl. No.: 19/011,312

(22) Filed: Jan. 6, 2025

(51) Int. Cl. G06F 40/42

(52) U.S. Cl. CPC G06F 40/42

(57) ABSTRACT

In some embodiments, a method receives a first translation for an instance of content. A first prompt is generated to refine the first translation. The first prompt includes instructions to refine the first translation and a scoring guide. The method inputs the first prompt into a large language model to generate a score for the first translation and suggestions for the first translation. The method evaluates the score to determine whether the first translation meets a threshold. When the score does not meet the threshold: the method generates a second prompt to refine the first translation, inputs the second prompt into the large language model to refine the first translation using one or more of the suggestions to generate a second translation, and provides feedback to the generate another first prompt to refine the second translation. When the score meets the threshold, the method outputs the first translation.

### BACKGROUND

A content delivery system may release content in multiple different countries. This may require translation of the content to multiple languages. The translations may use a large amount of resources and require a large amount of time. A machine translation may be used to reduce the translation time. However, the translation of media content may require integrating localized linguistic styles, which may not be captured in the machine translations. Also, the machine translations may lack human naturalness, such as the translation may be stiff, robotic, overly literal, and may not be appropriate for translations of media content.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for generating translations according to some embodiments.

FIG. 2 depicts a more detailed example of a server system according to some embodiments.

FIG. 3 depicts a simplified flowchart of a method for generating the critic prompt and refined prompt according to some embodiments.

FIG. 4 depicts an example of a prompt according to some embodiments.

FIG. 5 depicts an example of an output for the scoring system according to some embodiments.

FIG. 6 depicts an example of suggestions according to some embodiments.

FIG. 7 depicts a simplified flowchart for method for translating idioms according to some embodiments.

FIG. 8 illustrates one example of a computing device according to some embodiments.

### DETAILED DESCRIPTION

Described herein are techniques for a language translation system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A content delivery system may translate instances of content using a first translation system. In some examples, the first translation system may be an automatic translation by a machine translation or a translation by a large language model, but other translations may be used. The system may then refine the translation using a large language model. The system generates a prompt that directs the large language model to refine the translation. The prompt may be generated to refine the translation based on a style that is desired by the content delivery system (e.g., linguistic preferences for a location and also the preferences for the content delivery system). The prompt also provides a scoring guide to cause the large language model to output a score based on the translation. The score may rate the translation in an overall score, different categories, or both. The large language model may output suggestions to refine the translation and also a score (or scores). Based on the score, the system may further refine the translation using the suggestions, such as using other prompts to a large language model to adjust the translation. This process may continue until the score meets a threshold, and the refined translation is output.

The system may create improved translations that meet the requirements of the content delivery system. For example, the content delivery system may have stylistic requirements that can be incorporated into the translation using prompts to the large language model. The use of the specialized prompts may separate the refinement prompts that are used to improve the refined translation and the speed at which the refinements can be performed. Also, the scores use an analysis by the large language model to build in a score that can be used to automate the process. The score allows automated refinements to be performed using evaluations by the large language model until a refined translation is generated. This allows the translation to be performed without supervision.

### System

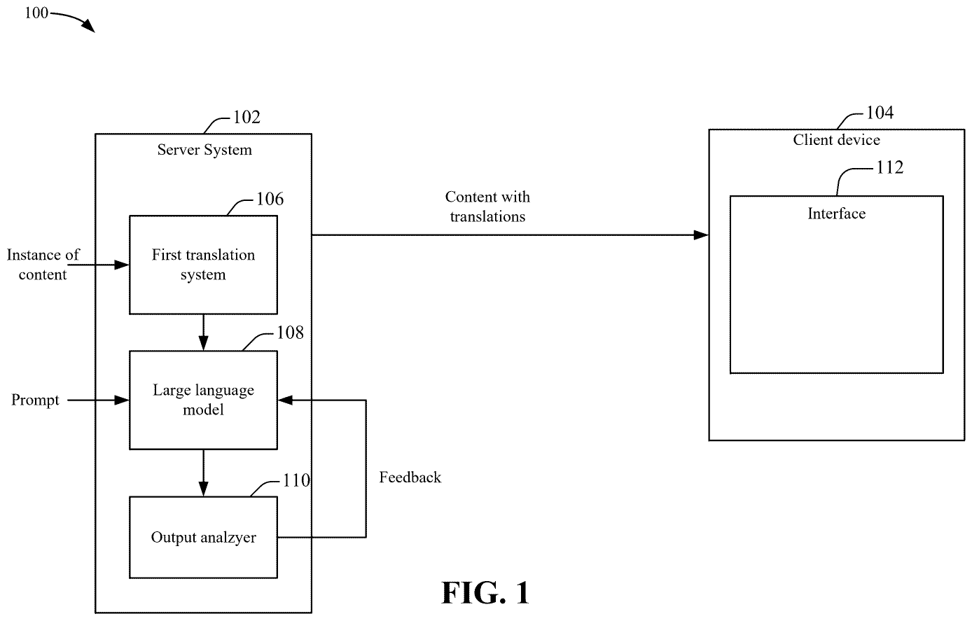

FIG. 1 depicts a simplified system 100 for generating translations according to some embodiments. System 100 includes a server system 102 and a client device 104. Although single instances of server system 102 and client device 104 are provided, multiple instances may be used.

Server system 102 may include one or more computing devices that provide a content delivery service for delivering content with translations from a source language to client device 104. Client device 104 may be a computing device that is capable of playing back content through an interface 112. In some examples, this playback may occur via a media player. Client device 104 may take many forms, such as a mobile phone, smartphone, set-top box, television, living room device, or tablet device. In some embodiments, client device 104 may display the content on interface 112 with a translation, such as an audio translation of an audio track or a translation of captions (e.g., subtitles) from an original audio track or original captions in an original language. In some examples, client device 104 may request a movie, show or other media content, and display the content with a translation. Although a content delivery service is described, embodiments may be used in other services that require translations.

Server system 102 may receive an instance of content. The instance of content may be video, audio, text, or other content. The instance of content may have an associated source language, which may be an original language of the content, or another language that needs to be translated. For example, English may be the original language of a movie or show that is spoken in the movie or show. Also, the source language that is input for translation may be text. In some embodiments, the dialogue may be detected using different recognition systems to generate the text. Also, captions for the instance of content may be used. Additional information may also be used to refine the text, such as a script for the instance of content.

A first translation system 106 may translate the source language to a target language. For example, the source language may be translated from English to Korean. Although one translation is discussed, the source language may be translated to multiple target languages using the described processes. In some embodiments, first translation system 106 may be a machine translation. For example, an application programming interface (API) may be used to send the text for the instance of content to a machine translation system. The machine translation system is configured to receive text and translate the text into translation of the instance of content. In other embodiments, first translation system 106 may be a large language model that receives a prompt that asks the large language model to perform a translation of the instance of content. The output of first translation system 106 may be a first translation.

A large language model 108 may receive the first translation and refine the first translation. A large language model may be based on neural networks and is configured to receive a prompt and uses the instructions in the prompt to output suggestions to refine the first translation. The prompt is natural language and the output of large language model 108 is natural language. The prompt may incorporate information that may improve the refinement process. For example, a style guide may provide information for a desired style, such as localization preferences or system specific style requirements. The prompt may also include instructions on how to perform the refinement, translation examples, and also a scoring guide. Large language model 108 receives the prompt and the first translation, and outputs information for a refined translation and a score (or scores) based on the scoring guide. In some embodiments, the information for the refined translation may be suggestions to adjust portions of the first translation and reasons the suggestions are provided. The score may rate a quality of the first translation.

An output analyzer 110 analyzes the information for the refined translation and the score. In some embodiments, output analyzer 110 may compare the score to a threshold to determine whether the first translation meets the threshold and does not need to be refined further, or does not meet the threshold and needs to be refined further. If the first translation needs to be refined further, output analyzer 110 may generate another prompt to large language model 108 to adjust the first translation, such as by accepting or rejecting the suggestions to generate a refined first translation, which may be referred to as a second translation. After adjusting the first translation, output analyzer 110 may provide feedback to large language model 108, which uses the feedback to generate another prompt to large language model 108 to score the second translation and provide suggestions to refine the second translation further. Another prompt may be generated based on which suggestions were accepted or rejected, or the scores from rating the first translation. This process may continue until the score meets the threshold.

The following will describe the translation process in more detail.

### Translation System

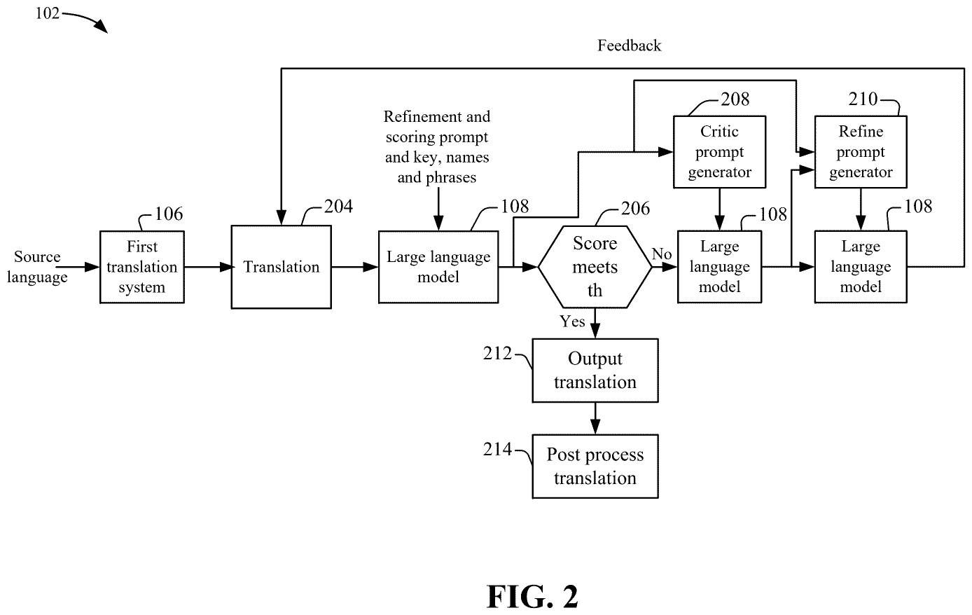

FIG. 2 depicts a more detailed example of server system 102 according to some embodiments. A source language for an instance of content is received at first translation system 106. In some embodiments, the source language that is received may be text for the instance of content. In some examples, the audio of the instance of content may be translated from a source language to a target language. For example, the original audio may be converted to text using a speech to text converter. After the translation, the translated text may be converted to audio using a text to speech converter. In other embodiments, captions for the instance of content may be used as the input text to be translated.

In some embodiments, first translation system 106 may send the source language to an application programming interface for a machine translation system. The machine translation system may translate the source language and return a first translation back to server system 102. The machine translation may be performed by different systems. In some embodiments, the machine translation system may be separate from server system 102, and be a standardized machine translation model that is not trained by the content delivery system.

In other embodiments, first translation system 106 may be a large language model. In some embodiments, the large language model may be the same model as large language model 108. To perform the first translation, the large language model may receive the source language and a prompt to perform the translation. In some embodiments, the prompt may include instructions to perform the translation, which may be general instructions to perform a translation without any style preferences from the content delivery system.

At 204, a first translation is output by first translation system 106. Then, the first translation is input into large language model 108 along with the source language. A refinement and scoring prompt may be input into large language model 108 with the first translation. The refinement and scoring prompt may provide information for refining the first translation, such as instructions, translation examples, a style guide, key names and phrases, and a scoring guide. The prompt instructions may instruct large language model 108 to perform a translation, such as a prompt of “You will be a Japanese language editor. I need to give you an English text, and then its Japanese translation. The output I want for you is to reference the style guide that I have given you, and edit the Japanese translation I supplied. I also supplied examples of Japanese translations from previous examples. Also, use the following scoring guide to generate scores for the first translation.” The translations from previous examples may include translations from source language to the target language.

The style guide may include information on the style of language in the translation that that is desired. For example, the style may include localized style preferences for a target language or content delivery system style requirements. The localized style preferences may be local linguistic choices based on local language customs for the target language. The content delivery style requirements may be style preferences based on the content delivery system and the style desired by it.

The key names and phrases may provide guidance on translating certain words. For example, this information is defined as a dictionary to specify certain names and each languages/translation for those words. An example of a prompt for key name and phases includes: “These are the characters’ names you can find the input text. Do not translate character names but rather use the corresponding names for each character you find below. The names are given as a JSON where keys are names in {slang} and values are the corresponding names that you must use in the translation. [Key character names and translations]. Here, slang is the source language and the list of key character names and translations is enforced. Also, another example is “These are terms and expressions you can find in the input text that you do not need to translate. When you find such terms or expressions in the input text, you must report the corresponding expression in the translation. The terms are given in a JSON where keys are terms in {slang} and values are the corresponding terms or expressions you must use in the translation. Terms or expressions: [key terms and translations]” Here, slang is the source language and the list of key terms and translations is enforced.

The scoring guide may provide a scoring system that can be used by large language model 108 to rate the first translation. The scoring system may include an overall score, categories of aspects of the first translations, and a scoring range to use.

Large language model 108 outputs suggestions to refine the first translation and scores. For example, large language model 108 may evaluate the first translation and the source language to provide refinement suggestions, such as the suggestions may be edits to the first translation and reasoning as to why the edits were suggested. In some embodiments, large language model 108 may compare the source language and first translation while using the style guide and translation examples to determine where portions of the first translation may be refined. For example, the style guide may be used to identify some words that may be translated differently due to local linguistic styles. Also, the scores may rate the quality of the translation based on the scoring guide. The use of the scores may allow server system 102 to iteratively adjust the translation automatically until an acceptable translation is received. The use of large language model 108 to score the translation uses features of large language model 108 to automate the iterative translation process. This improves the speed at which a translation can be performed because the process is automated and also the translation can be performed faster. In the automated process, server system 102 determines if a score does not meet a threshold (e.g., is less than). In some embodiments, an overall score may be compared to a threshold. Also, multiple scores may be output and each score may be compared to a threshold. In other embodiments, the multiple scores may be combined into a single score, and a single score may be compared to a threshold. When the score does not meet the threshold, such as is less than the threshold, the translation may be further refined. However, at 212, when the score meets a threshold, such as is greater than the threshold, the refined translation may be output by server system 102. At 214, post processing of the translation may be performed. This may be based on a style guide for the translation to enforce specific code based instructions for the language. Examples of code based instructions include changes em dashes for en-dashes, no multiple exclamation marks, etc. The code based instruction may be run without a large language model to interpret the instructions.

When the score does not meet the threshold, the first translation may be further refined. As mentioned above, large language model 108 may evaluate the first translation and provide refinement suggestions. A critic prompt generator 208 may receive the refinements and generate a prompt that may ask large language model 108 to evaluate the suggestions, such as to determine whether to accept or reject the suggestions. For example, critic prompt generator 208 generates a critic prompt for large language model 108. The critic prompt may have instructions for large language model 108 to accept or reject suggestions for the translation. For example, the suggestions may be based on the scores that were provided. If some categories have lower scores, such as the spelling or a grammar may be incorrect. Critic prompt generator 208 generates a critic prompt that asks large language model 108 to focus on improving the spelling or grammar due to the score in the category of spelling or grammar being low. Here, large language model 108 may be more likely to accept suggestions that correct spelling or grammar. Also, the suggestions may have been specific suggestions for changing the translation, such as a suggestion is to change a word due to the spelling being different in a locality. Large language model 108 may review the suggestions and output which suggestions should be accepted.

Then, a refine prompt generator 210 may determine a refine prompt to refine the first translation. For example, refine prompt generator 210 may provide instructions that ask large language model 108 to refine the first translation based on the accepted or rejected suggestions. Large language model 108 may refine the first translation based on recommendations for accepting or rejecting the suggestions, and outputs a refined first translation, which may be referred to as a second translation. After further refinement, the second translation may be re-input into large language model 108 at 204, and the refinement and scoring prompt is used to refine the second translation. The second translation may be scored and compared to the threshold again. If the second translation meets the threshold, then the second translation may be output. If the second translation does not meet the threshold, then the second translation is refined using the critic prompt and the refine prompt again with any new suggestions or new scores that are output for the second translation.

The use of the separate prompts may improve the process and translation. For example, using the critic prompt and refine prompt allows large language model 108 to focus on specific tasks. Also, the critic prompt and the refine prompt may be dynamically generated based on the scores. The splitting of the critic prompt and the refine prompt from the refinement and scoring prompt may allow these prompts to be dynamically generated. Also, the analysis by large language model 108 may be performed faster because the respective prompts are focused on specific tasks rather than all three tasks at once. Splitting the prompts in the refinement process helps to separate the problem into simpler sub-problems. The refinement problems may be separated into: (i) the evaluation of the first translation and proposal of ways of improving the incorrect translations, (ii) the acceptance of new suggestions for improving the translations, (iii) the application of the suggested and accepted revisions. This avoids overloading the large language model with too many instructions that it cannot follow all at once. Focusing the prompt to specific instruction helps make sure the large language model can accurately apply the requirements. If there are too many requirements all at once in single prompt, the large language model can make its own decision of which requirements to prioritize. Splitting the prompt helps in prioritizing the requirements.

The following will now describe the generation of the critic prompt and refine prompt in more detail.

### Critic and Refine Prompt Generation

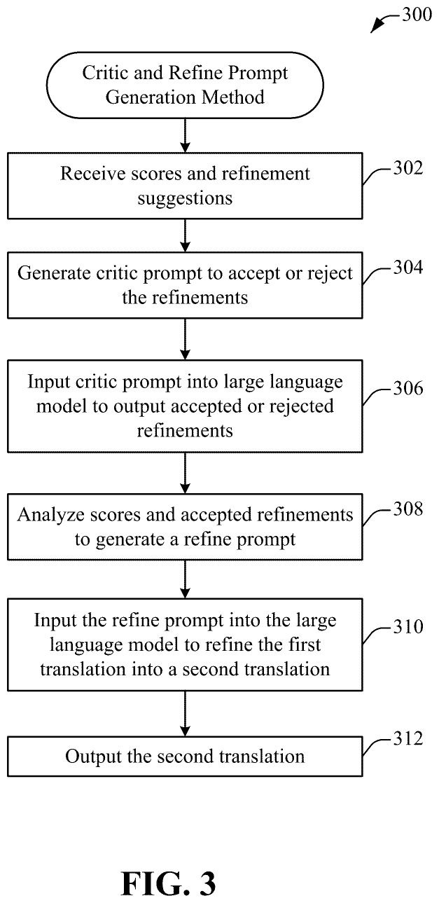

FIG. 3 depicts a simplified flowchart 300 of a method for generating the critic prompt and refine prompt according to some embodiments. At 302, critic prompt generator 208 receives the scores and refinement suggestions from large language model 108. At 304, critic prompt generator 208 analyzes the scores and the refinement suggestions to generate a critic prompt to accept or reject the refinements. The critic prompt may use the scores and refinement suggestions to formulate the critic prompt. The critic prompts are dynamically generated by critic prompt generator 208 by evaluating the scores and proposes improvements to the first translation.

At 306, critic prompt generator 208 inputs a critic prompt into large language model 108, which outputs accepted or rejected suggestions. For example, large language model 108 may use the prompt to accept or reject suggestions based on the scores. The scores may be used to filter out (reject) translation suggestions produced by large language model 108 and to exit from the refinement loop. The scores produced by large language model 108 reflect the severity of the translation, the higher the severity, the more important the issue related to the translation. Translation suggestions could contain false positives, meaning that translation errors are flagged when instead the translation is correct. The role of the critic prompt generator 208 is to have large language model 108 reject suggestions of lower severity and false positives. Then the scores are used to exit the refinement loop. That is, the scores may be compared to thresholds to perform actions. Also, large language model 108 can be asked to determine why the score is low and to improve upon the score.

At 308, refine prompt generator 210 analyzes the accepted suggestions to generate a refine prompt. The refine prompt may include instructions to refine the first translation based on the accepted suggestions.

At 310, refine prompt generator 210 inputs the refine prompt into large language model 108, which refines the first translation to generate a second translation. Large language model 108 may use the accepted suggestions and the refine prompt to refine the translation. For example, some changes suggested by the suggestions may be used to adjust the first translation. At 312, the second translation is output.

### Examples

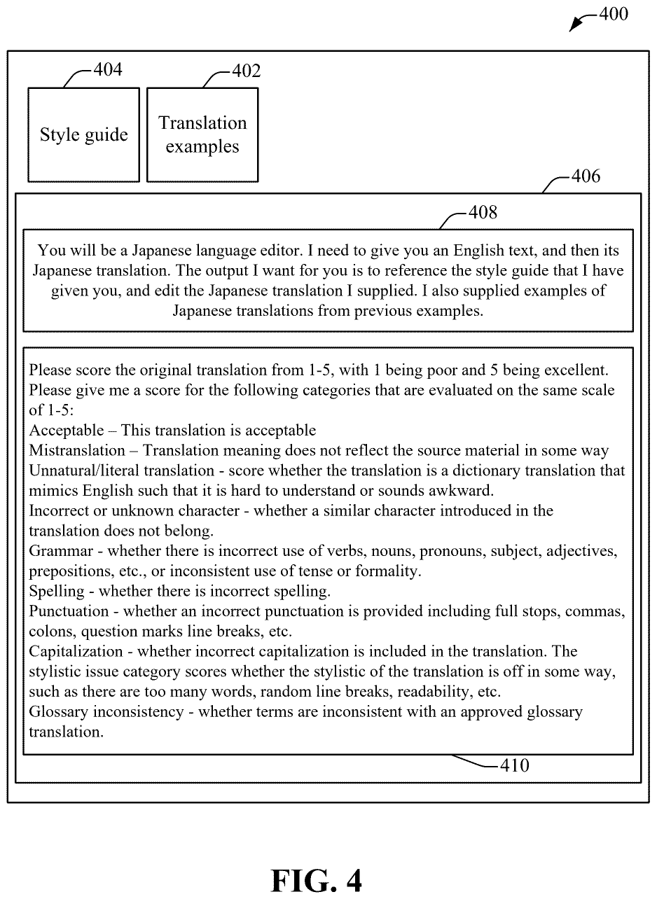

FIG. 4 depicts an example 400 of a refinement and scoring prompt according to some embodiments. The prompt includes examples of previous translations at 402 and a style guide at 404. The translation examples or style guide may be attached to the prompt or included as text in the prompt. Also, text for the prompt at 406 is provided with instructions and a scoring guide.

In some embodiments, the prompt may include text at 408 that includes instructions for the large language model 108. For example, the prompt may state “You will be a Japanese language editor. I need to give you an English text, and then its Japanese translation. The output I want for you is to reference the style guide that I have given you, and edit the Japanese translation I supplied. I also supplied examples of Japanese translations from previous examples.” The instructions may direct large language model 108 to analyze the English text and the Japanese translation to determine any refinement suggestions.

At 410, a scoring guide is provided for a scoring system. For example, the scoring guide may include categories, such as acceptable, mistranslation, unnatural/literal translation, incorrect or unknown character, grammar, spelling, punctuation, capitalization, stylistic issue, glossary inconsistency, etc. Also, the guidance may include a scoring system, such as the categories may be scored on a scale of 1 to 5, where 1 is considered poor, and 5 is considered excellent, but other scoring systems may be used. Although these categories are listed, other categories may be used. The acceptable category may determine whether this translation is acceptable. The mistranslation category may score whether the translation meaning does not reflect the source language in some way. The unnatural/literal translation may score whether the translation is a dictionary translation that mimics English such that it is hard to understand or sounds awkward. The incorrect or unknown character category scores whether a similar character introduced in the translation does not belong. The grammar category scores whether there is incorrect use of verbs, nouns, pronouns, subject, adjectives, prepositions, etc., or inconsistent use of tense or formality. The spelling category scores whether there is incorrect spelling. The punctuation category scores whether an incorrect punctuation is provided including full stops, commas, colons, question marks line breaks, etc. The capitalization category scores whether incorrect capitalization is included in the translation. The stylistic issue category scores whether the stylistic of the translation is off in some way, such as there are too many words, random line breaks, readability, etc. The glossary inconsistency category scores whether terms are inconsistent with an approved glossary translation.

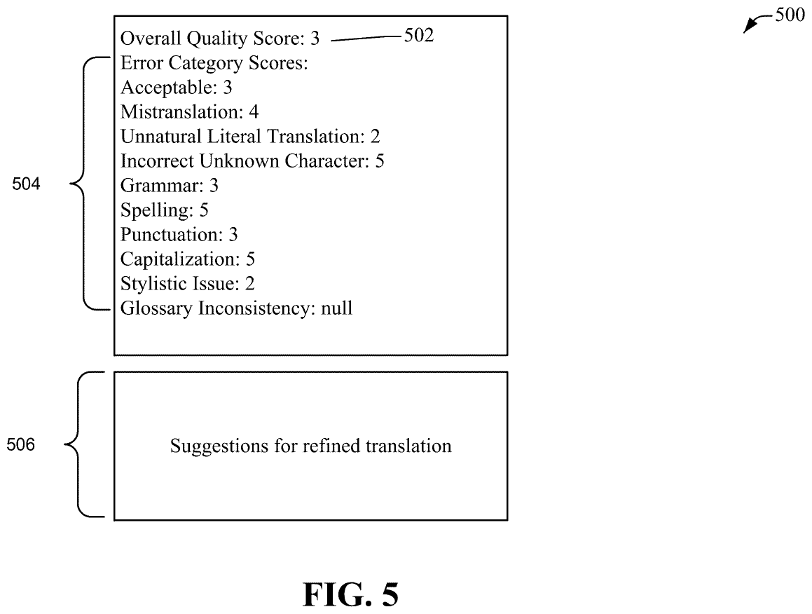

FIG. 5 depicts an example 500 of an output for the scoring system according to some embodiments. Here, the categories may be listed and respective scores are provided. At 502, an overall quality score may be determined. The overall quality score may be the value of three. The overall quality score may rate the overall translation. In some embodiments, the overall quality score may be based on the scores from the categories. In other embodiments, the overall quality score may be based on an overall assessment of the first translation based on the source language. The specific category scores are provided at 504. For example, the acceptable category has a score of three, the mistranslation category as a score of four, etc. The specific category scores are based on an analysis of each category for the translation. An edited translation may also be included at 506, and it noted as suggestions for refining the translation. The refinements may include suggestions, such as a suggestion may be to replace a first word with a second word. Also, the refinements may be incorporated as replacement text in the first translation.

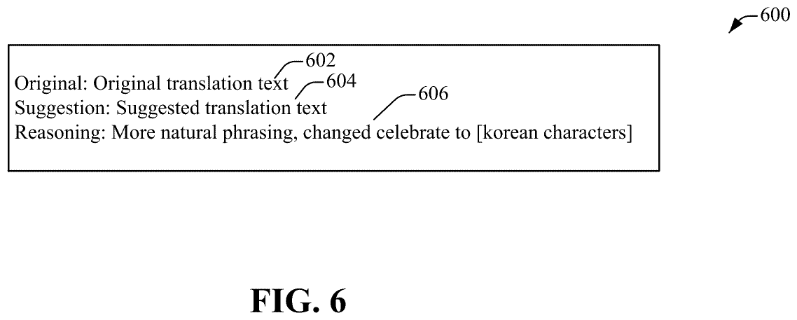

FIG. 6 depicts an example 600 of a suggestion according to some embodiments. A suggestion may include the original translation text at 602. At 604, the suggested translation text may be a suggestion for an edit to the original translation text. At 606, a reasoning for the change is provided. In this example, the reasoning may state the suggestion is suggested for more natural phrasing that changes the word quite “celebrates” to a different character translation represented by [Korean characters]. Other refinement suggestions may also be provided with the original translation text, suggested translation text, and reasoning for the suggestions. A score for the suggestions may also be provided, but is not shown. The score may rate the confidence of the suggestion, such as how confident large language model 108 is that the suggestion should be accepted. The score may be used by large language model 108 to decide whether to accept or reject suggestions. For example, higher confidence scores may make it more likely that a suggestion is accepted.

### Idioms

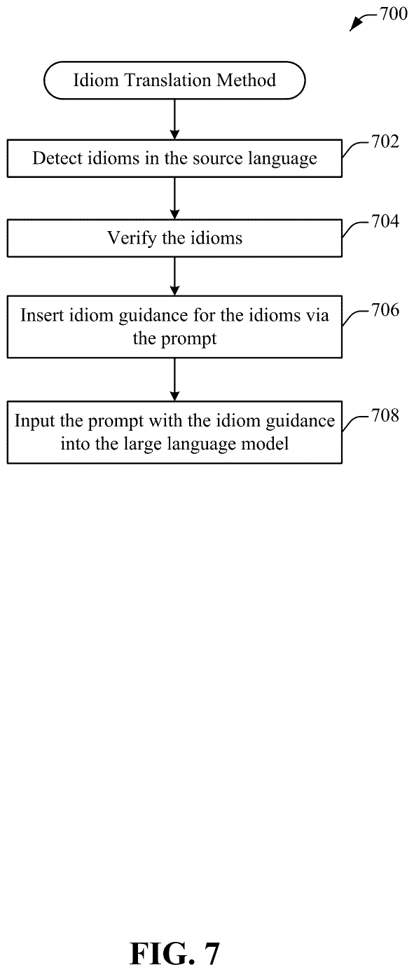

Server system 102 may also translate idioms according to some embodiments. FIG. 7 depicts a simplified flowchart 700 for method for translating idioms according to some embodiments. Idioms may not make literal sense when translated word-for-word into another language. Also, idioms may have different meanings in different languages and also may have different meanings in different contexts. This makes translation of idioms difficult.

At 702, server system 102 detects idioms in the source language. For example, the detection of idioms may be performed in different ways, such as the source language may be analyzed using a model to flag idioms. In other embodiments, idioms may be manually determined. The idioms may be associated with lines of text from the source language.

At 704, server system 102 may verify the idioms. In some embodiments, server system 102 may review lines of text around where idiom occurs and analyzes the lines of text to determine if an idiom is being used. Based on the analysis, some idioms may be verified as idioms and some idioms may not be verified. From the verified idioms, server system 102 may insert idiom guidance for the idioms via the prompt. The idiom guidance may identify the idioms in the lines of text, and also provide suggestions for translating the idiom. The suggestions may be based on the target language, context for the idiom, or other information that is useful when translating the idiom.

At 708, server system 102 may input the prompt with the idiom guidance into large language model 108. Large language model 108 may then use the idiom guidance when translating the associated line of text. This may improve the translation as large language model 108 may have guidance as to how the idiom should be translated.

### Conclusion

Accordingly, a system provides an improved translation. Feedback is provided to refine the translation in an automated manner. In some embodiments, a scoring system is used to automate the refinement. The result is an improved translation that uses less computing resources.

### System

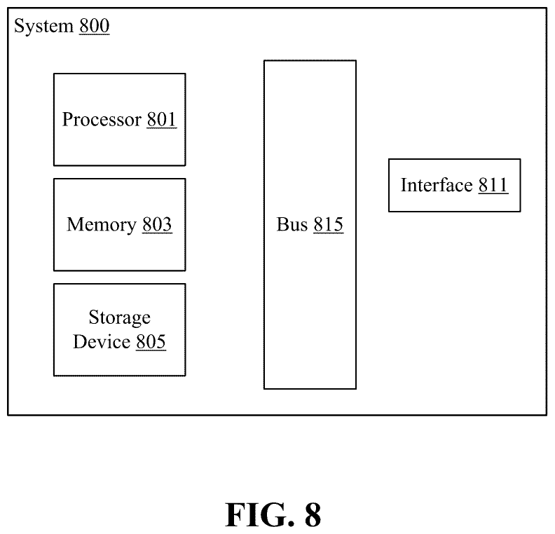

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices such as server system 102 or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving a first translation for an instance of content;
generating a first prompt to refine the first translation, wherein the first prompt includes instructions to refine the first translation and a scoring guide;
inputting the first prompt into a large language model to generate a score for the first translation and suggestions for the first translation;
evaluating the score to determine whether the first translation meets a threshold;
when the score does not meet the threshold:
generating a second prompt to refine the first translation using the suggestions;
inputting the second prompt into the large language model to refine the first translation using one or more of the suggestions to generate a second translation;
providing feedback to generate another first prompt to refine the second translation using the large language model; and
when the score meets the threshold, outputting the first translation.

2. The method of claim 1, wherein receiving the first translation comprises:
sending information for the instance of content to a system to perform the first translation.

3. The method of claim 2, wherein the information comprises text from audio of the instance of content or text from captions of the instance of content.

4. The method of claim 1, wherein sending information for the instance of content comprises:
sending the information to an interface for a machine translation, wherein the machine translation uses a model that is configured to translate text as input into the first translation.

5. The method of claim 1, wherein sending information for the instance of content comprises:
sending the information to the large language model with a third prompt to perform the translation, wherein the third prompt is different from the first prompt.

6. The method of claim 1, wherein generating the first prompt comprises:
generating instructions to refine the first translation; and
generating the scoring guide describing scores to generate for the first translation.

7. The method of claim 6, wherein generating the first prompt comprises:
adding translation examples for the first translation; and
adding a style guide that explains local linguistic preferences for the first translation or preferences for a content delivery service that is delivering the instance of content.

8. The method of claim 1, wherein the suggestions comprise edits to a portion of the first translation.

9. The method of claim 8, wherein the suggestions comprise reasons why the edits were generated.

10. The method of claim 1, wherein the score comprises a first score that rates the first translation, wherein the first score is compared to the threshold.

11. The method of claim 10, wherein the score comprises a set of second scores that rate the first translation in a plurality of categories.

12. The method of claim 1, wherein the score is used to generate the second prompt to refine the first translation.

13. The method of claim 1, wherein the second prompt is used as first instructions to the large language model to accept or reject the suggestions to refine the first translation.

14. The method of claim 13, wherein the second prompt is used as second instructions to the large language model to refine the first translation based on the accepted or rejected suggestions to generate the second translation.

15. The method of claim 13, wherein:
the feedback comprises the second translation and information on the suggestions that were accepted or rejected or the score, and
the another first prompt uses the information to generate the instructions for the large language model to refine the second translation.

16. The method of claim 1, further comprising:
inputting the another prompt into the large language model to generate a score for the second translation and suggestions for the translation;
evaluating the score for the second translation to determine whether the second translation meets the threshold;
when the score does not meet the threshold:
generating a third prompt to refine the second translation using the suggestions;
inputting the third prompt into the large language model to refine the second translation using one or more of the suggestions to generate a third translation;
providing feedback to the generate another first prompt to refine the third translation using the large language model; and
when the score for the second translation meets the threshold, outputting the second translation.

17. A non-transitory computer-readable storage medium having stored thereon computer executable instructions, which when executed by a computing device, cause the computing device to be operable for:
receiving a first translation for an instance of content;
generating a first prompt to refine the first translation, wherein the first prompt includes instructions to refine the first translation and a scoring guide;
inputting the first prompt into a large language model to generate a score for the first translation and suggestions for the first translation;
evaluating the score to determine whether the first translation meets a threshold;
when the score does not meet the threshold:
generating a second prompt to refine the first translation using the suggestions;
inputting the second prompt into the large language model to refine the first translation using one or more of the suggestions to generate a second translation;
providing feedback to generate another first prompt to refine the second translation using the large language model; and
when the score meets the threshold, outputting the first translation.

18. The non-transitory computer-readable storage medium of claim 17, wherein generating the first prompt comprises:
generating instructions to refine the first translation; and
generating the scoring guide describing scores to generate for the first translation.

19. The non-transitory computer-readable storage medium of claim 17, wherein:
the feedback comprises the second translation and information on the suggestions that were accepted or rejected or the score, and
the another first prompt uses the information to generate the instructions for the large language model to refine the second translation.

20. An apparatus comprising:
one or more computer processors; and
a computer-readable storage medium comprising instructions for controlling the one or more computer processors to be operable for:
receiving a first translation for an instance of content;
generating a first prompt to refine the first translation, wherein the first prompt includes instructions to refine the first translation and a scoring guide;
inputting the first prompt into a large language model to generate a score for the first translation and suggestions for the first translation;
evaluating the score to determine whether the first translation meets a threshold;
when the score does not meet the threshold:
generating a second prompt to refine the first translation using the suggestions;
inputting the second prompt into the large language model to refine the first translation using one or more of the suggestions to generate a second translation;
providing feedback to generate another first prompt to refine the second translation using the large language model; and
when the score meets the threshold, outputting the first translation.
